(19) United States
(12) Patent Application Publication
(10) Pub. No.: US 2010/0097517 A1
(43) Pub. Date: Apr. 22, 2010

(54) APPARATUSES AND METHODS FOR SAVING POWER USED BY A DIGITAL IMAGE PROCESSING DEVICE

(75) Inventor: Sung-shik Koh, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/498,519

(22) Filed: Jul. 7, 2009

(30) Foreign Application Priority Data
Oct. 22, 2008 (KR) 10-2008-0103723

(51) Int. Cl. H04N 5/225

(52) U.S. Cl. 348/372; 348/E05.024

(57) ABSTRACT

Provided are apparatus and method for saving power used by a digital image processing device by determining whether the digital image processing device is held and, if the device is not held, signaling that the digital image processing device may enter a power save mode. The power saving device may include: a digital image processing unit arranged to determine that the device is not being held and to signal the device to enter a power save mode if substantially no image change occurs between frames generated by the digital image processing device.

### CROSS-REFERENCE TO RELATED PATENT APPLICATION

This application claims the benefit of Korean Patent Application No. 10-2008-0103723, filed on Oct. 22, 2008 in the Korean Intellectual Property Office, the entire contents of which is incorporated herein in by reference.

### BACKGROUND OF THE INVENTION

1. Field of the Invention

The present invention generally relates to digital image processing apparatuses and methods, and more particularly, to apparatuses and methods for saving power used by a digital image processing device by automatically determining whether the digital image processing device is held.

2. Description of the Related Art

Because portable digital image processing devices often have limited battery capacity, it is important to optimize the power used by the digital image processing device.

Some digital image processing devices have a power save mode which is entered after a fixed amount of time of inactivity, for example they may have a standby time of 30 seconds. But this standby time is often fixed and based on a menu setting and may not take into account the manner in which the device is being used.

Since the conventional power save mode standby time is fixed, the digital image processing device may consume unnecessary power.

### SUMMARY OF THE INVENTION

The present invention provide apparatuses and methods for saving power used by a digital image processing device by determining whether the digital image processing device is held, and, if the digital image processing device is not held, signaling to the digital image processing device to enter a power save mode, thereby reducing power consumption.

According to an aspect of the present invention, there is provided a power saving digital image processing device comprising: a digital image processing unit arranged to determine that the device is not being held and to signal to the device to enter a power save mode if substantially no image change occurs between frames generated by the digital image processing device.

The digital signal processing unit may comprise: an area establishing unit establishing predetermined areas in the generated frames; a comparison unit arranged to compare between the established areas of the generated frames; and a control unit arranged to determine that the device is not being held and to enter the device a power save mode if substantially no image change occurs between the established areas of the generated frames.

The control unit may determine that the device is not being held and may signal to the device to enter the power save mode if substantially no image change occurs between the established areas of frames generated for a predetermined period of time by the digital image processing device.

The control unit may be arranged to determine if a substantial image change occurs between the established areas of frames generated by the digital image processing device during the predetermined period of time, and if a substantial image change occurs, then determine that the digital image processing device is being held and reset the predetermined period of time.

According to an embodiment, there is provided a power saving digital image processing device comprising: a digital image processing unit arranged to determine that the device is not being held and arranged to signal to the device to enter a power save mode if substantially no change occurs between auto-focus (AF) values calculated from frames generated by the digital image processing device. The digital image processing may comprise an AF value calculating unit arranged to calculate an integration value of a high frequency component from a predetermined area of the frames; and a comparison unit arranged to compare between the AF values calculated from the predetermined area of the frames; and a control unit arranged to signal to the device to enter a power save mode if substantially no change occurs between the AF values calculated from the frames. The control unit may be arranged to enter the device into the power save mode if substantially no change occurs between the calculated AF values calculated from the frames generated within the predetermined period of time.

The control unit may be arranged to reset the predetermined period of time, if a substantial change occurs between the AF values calculated from the frames generated within the predetermined period of time.

According to an embodiment, there is provided a digital image processing unit arranged to determine that the device is not being held and to signal to the device to enter into a power save mode if substantially no change occurs between AE values calculated from frames.

The digital image processing unit may comprise: an AE value calculating unit arranged to calculate a brightness value of an image from a predetermined area of the frame; a comparison unit arranged to compare between AE values calculated from the predetermined area of the frames; and a control unit arranged to enter the device into a power save mode if substantially no change occurs between the AE values calculated from the frames.

The control unit may be arranged to signal to the device to enter the power save mode if substantially no change occurs between the AE values of the frames generated within the predetermined period of time.

The control unit may be arranged to reset the predetermined period of time if a substantial change occurs between the AE values calculated from the frames generated within the predetermined period of time.

According to an embodiment, there is provided a method of operating a digital image processing device. The method may comprise determining whether a substantial change occurs between frames of images generated by the device. The method may further include if no substantial change occurs, then determining that the digital image processing device is not held, and signaling the digital image processing device to enter a power save mode. The determining whether a substantial change occurs may comprise determining whether a substantial change occurs between frames of images generated by the device for a predetermined period of time, and if a substantial change occurs within the predetermined time, then resetting the predetermined period of time, otherwise determining that no substantial change occurred.

In an embodiment, there is provided a method of operating a digital image processing device, the method comprises determining whether a substantial change occurs between AF values calculated from frames generated by the device. The method may further comprise if no substantial change occurs, then determining that the digital image processing device is not held, and entering the digital image processing device into a power save mode. The determining whether a substantial change occurs may comprise determining whether a substantial change occurs between AF values calculated from frames generated by the device for a predetermined period of time, and if a substantial change occurs within the predetermined time, then resetting the predetermined period of time, otherwise determining that no substantial change occurred.

In an embodiment, there is provided a method comprising determining whether a substantial change occurs between calculated AE values of frames generated by the device; and if no substantial change occurs, then determining that the digital image processing device is not held, and signaling to the digital image processing device to enter into a power save mode.

The determining whether a substantial change occurs may comprise determining whether a substantial change occurs between AE values calculated from frames generated by the device for a predetermined period of time, and if a substantial change occurs within the predetermined time, then resetting the predetermined period of time, otherwise determining that no substantial change occurred.

### BRIEF DESCRIPTION OF THE DRAWINGS

The above and other features and advantages of the present invention will become more apparent by describing in detail an embodiment thereof with reference to the attached drawings in which:

FIG. 1 is a perspective view illustrating the front and top of an example of a digital image processing device;

FIG. 2 is a back view of the example of a digital image processing device illustrated in FIG. 1;

FIG. 3 is an example of a block diagram of an apparatus for saving power of the digital image processing device shown in FIG. 1 according to an embodiment of the present invention;

FIG. 4 is an example of a block diagram of an apparatus for saving power of the digital image processing device shown in FIG. 1 according to another embodiment of the present invention;

FIG. 5 is an example of a block diagram of an apparatus for saving power of the digital image processing device shown in FIG. 1 according to another embodiment of the present invention;

FIGS. 6A and 6B are examples of diagrams for explaining a power save mode according to the apparatus shown in FIG. 3;

FIG. 7 is a flowchart illustrating an example of a method of saving power of a digital image processing device according to an embodiment of the present invention;

FIG. 8 is a flowchart illustrating an example of a method of saving power of the digital image processing device according to an embodiment of the present invention; and

FIG. 9 is a flowchart illustrating an example of a method of saving power of the digital image processing device according to an embodiment of the present invention.

### DETAILED DESCRIPTION OF THE INVENTION

Hereinafter, an embodiment of the present invention will be described in detail with reference to the accompanying drawings.

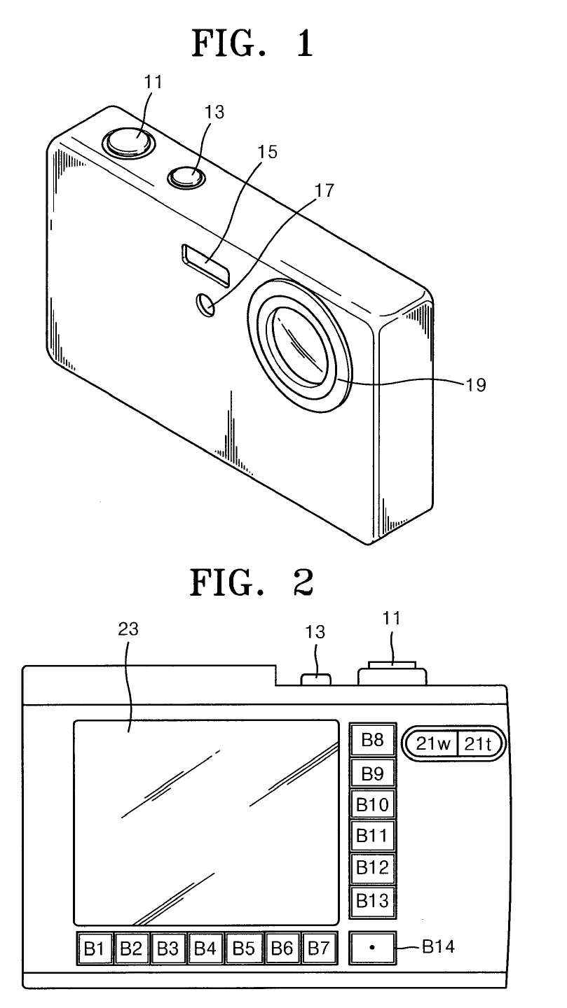

FIG. 1 is a perspective view illustrating the front and top of an example of a digital image processing device. Referring to FIG. 1, the digital image processing device includes a shutter-release button 11, a power button 13, a flash 15, a sub light 17, and a lens unit 19 in its front and top.

The shutter-release button 11 is opened and closed in order to expose a charge coupled device (CCD) or a film to light for a predetermined amount of time and records an image in the CCD by appropriately exposing an object in cooperation with an iris (not shown).

In an embodiment, the shutter-release button 11 generates a first photographing signal and a second photographing signal according to a user input. Upon a first manipulation of the shutter-release button 11 to generate a half-shutter signal, the digital image processing device adjusts a focus and the amount of light. When the digital image processing device is in focus, a green light is turned on in a display unit. After the digital image processing device finishes focusing and adjusting the amount of light in response to the first manipulation of the shutter-release button 11, the shutter-release button 11 is manipulated a second time so as to generate a full-shutter signal for photographing.

The power button 13 is manipulated in order to operate the digital image processing device by supplying power to the digital image processing device.

The flash 15 momentarily illuminates an object for photographing in a dark environment. In an embodiment, the flash 15 has flash modes such as auto flash, fill flash, flash off, red-eye reduction, slow sync, and the like.

In an embodiment, the sub light 17 illuminates an object in order to allow the digital image processing device to quickly and accurately adjust a focus in an automatic manner in insufficient light or night photographing conditions.

The lens unit 19 receives light from an external light source and processes an image.

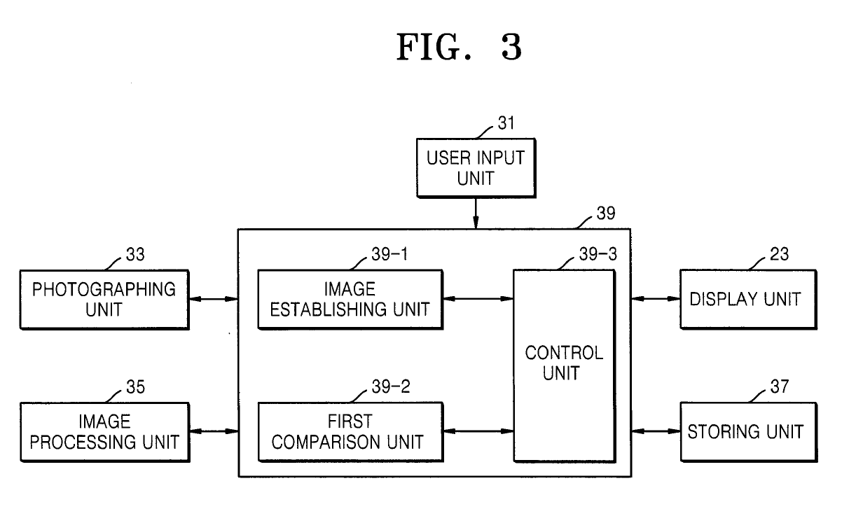

FIG. 2 is a back view of the example of a digital image processing device illustrated in FIG. 1. Referring to FIG. 2, the digital image processing device includes a wide-angle zoom button 21w, a telephoto zoom button 21t, a display unit 23, and input buttons B1 through B14 having touch sensors or contact switches in its back.

In an embodiment, when the wide-angle zoom button 21w or the telephoto zoom button 21t is input, the angle of view becomes wider or narrower. In an embodiment, the wide-angle zoom button 21w or the telephoto zoom button 21t is input in order to change the size of a selected exposure region. The size of the selected exposure region is reduced upon input of the wide-angle zoom button 21w, and the size of the selected exposure region increases upon input of the telephoto zoom button 21t.

In an embodiment, the input buttons B1 through B14 are provided in a horizontal line and a vertical line of the display unit 23. The input buttons B1 through B14 may have touch sensors (not shown) or contact switches (not shown).

In an embodiment, when the input buttons B1 through B14 have touch sensors, the user can select an arbitrary value, e.g., color or brightness, from a main menu item or can activate a sub menu icon included in a main menu icon, by moving a finger up/down/left/right while touching the buttons B1 through B7 in the horizontal line or the buttons B8 through B14 in the vertical line.

In an embodiment, when the input buttons B1 through B14 have contact switches, the user can execute a desired function by directly selecting a main menu icon and a sub menu icon thereof. A touch sensor input requires a weak touch when compared to a contact switch input, but the contact switch input requires a strong touch when compared to the touch sensor input.

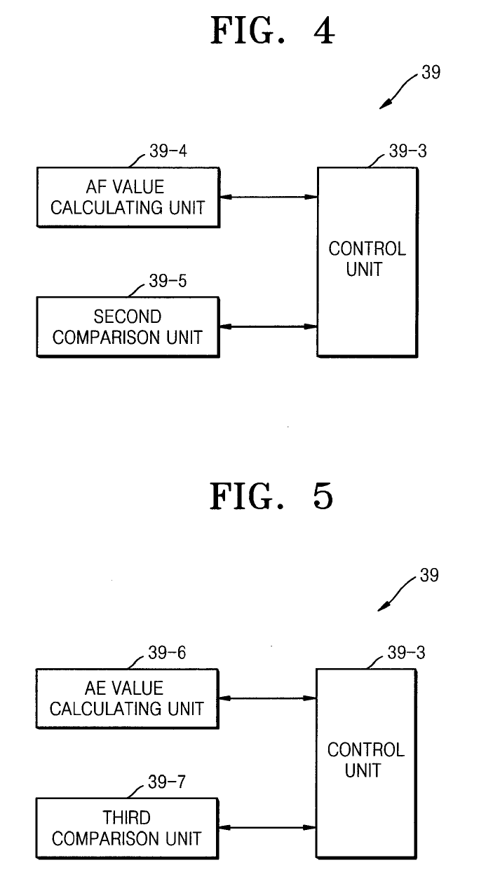

FIG. 3 is an example of a block diagram of a device for saving power of the digital image processing device shown in FIG. 1. Referring to FIG. 3, the apparatus includes the display unit 23, a user input unit 31, a photographing unit 33, an image processing unit 35, a storing unit 37, and a digital signal processing unit 39.

In an embodiment, the user input unit 31 includes the shutter-release button 11 that is used to open or close an iris to expose a CCD or a film to light for a predetermined amount of time, the power button 13 that is manipulated to supply power, the wide-angle zoom button 21w and the telephoto zoom button 21t are manipulated to increase or reduce the angle of view, and the buttons B1 through B14 that have touch sensors or contact switches and are provided in a horizontal line and a vertical line around the display unit 23.

In an embodiment, the photographing unit 33 includes a shutter, a lens unit, a motor unit, an iris, a CCD, and an analog-to-digital converter (ADC) that are not shown in the figures. The shutter is used to adjust the amount of light for light exposure in cooperation with the iris. The lens unit receives light from an external light source and processes an image. The iris adjusts the amount of incident light according to the amount of opening/closing thereof. The amount of opening/closing of the iris is controlled by the digital signal processing unit 39.

In an auto-focus mode, the focus motor is driven by controlling a focus lens under control of the digital signal processing unit 39. Thus, the focus lens may be moved from a forefront position to a rearmost position. In an embodiment, during this stage, a position of the focus lens at which there is a largest number of high-frequency components of an image signal, e.g., the number of driving steps of the focus motor, is set.

In an embodiment, the CCD accumulates the amount of light input through the lens unit and outputs an image captured through the lens unit in synchronization with a vertical sync signal according to the accumulated amount of light. The digital image processing device can obtain an image by means of the CCD that converts light reflected from an object into an electric signal. In order to obtain a color image using the CCD, a color filter is required and a color filter array (CFA) is generally used as a filter (not shown).

In an embodiment, the CFA has a structure in which filters pass light expressing only one color for each pixel and are regularly arranged, and may take various forms according to its arrangement structure. The ADC converts an analog image signal output from the CCD into a digital signal.

In an embodiment, the image processing unit 35 performs signal processing to allow digital-converted raw data to be displayed. The image processing unit 35 removes a black level caused by dark current in the CCD and the CFA that are sensitive to temperature change.

In an embodiment, the image processing unit 35 performs gamma correction for encoding information in consideration of the nonlinearity of human vision. In an embodiment, the image processing unit 35 performs CFA interpolation by interpolating a Bayer pattern implemented by RGRG lines and GBGB lines of gamma-corrected predetermined data into RGB lines.

In an embodiment, the image processing unit 35 converts the interpolated RGB signal into a YUV signal, performs edge compensation by filtering Y signals by using a high-pass filter and color correction by correcting color values of U and V signals by using a standard color coordinate system, and removes noise from the U and V signals.

In an embodiment, the image processing unit 35 compresses and signal-processes the YUV signals from which noise has been removed, and generates a JPEG file. The JPEG file is displayed in the display unit 23 and is stored in the storing unit 37. In an embodiment, the image processing unit 35 operates under the control of the digital signal processing unit 39.

In an embodiment, the digital signal processing unit 39 compares images between frames generated by the digital image processing device, and if substantially no change occurs between the images, then the digital signal processing unit 39 determines that the digital image processing device is not being held, and signals to the digital image device to enter a power save mode. In an embodiment, the digital image processing device enters a power saving mode upon receiving the signal from the digital signal processing unit 39. In an embodiment, the digital image device may not enter the power save mode depending on other factors including user menu settings and user behavior, for example, if the digital image device is being heavily used it may not enter a power saving mode to avoid inconveniencing the user. In an embodiment, the digital signal processing unit 39 includes an image establishing unit 39-1, a first comparison unit 39-2, and a control unit 39-3. Although not shown, in an embodiment, the control unit 39-3 includes a counter for counting a standby time to enter the power save mode.

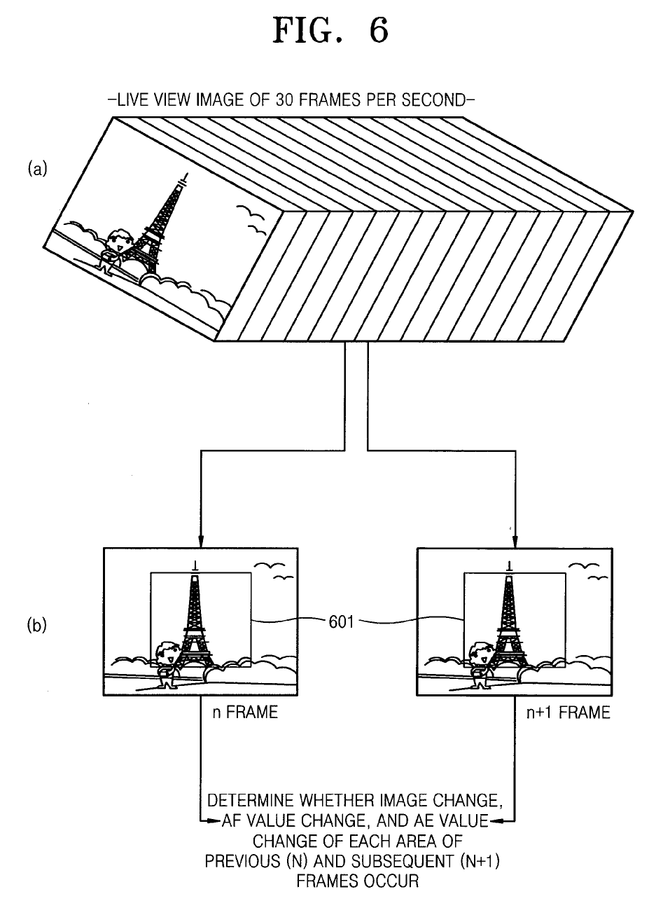

In an embodiment, the image establishing unit 39-1 establishes a predetermined area in an image frame. FIG. 6A shows an example of an image photographed at a rate of 30 frames per second. FIG. 6B shows areas 601 established in the series of frames. The areas 601 of the present embodiment may be AF areas. In embodiment, the first comparison unit 39-2 compares the areas 601 established in the previous and subsequent frames. In an embodiment, the first comparison unit 39-2 may compare the previous(n) and subsequent(n+1) frames where n varies with each new frame that is generated by the device.

In an embodiment, the control unit 39-3 controls the digital image processing device to enter the power save mode if no image change occurs in the areas 601 established in the frames generated during a period of time determined by a standby time. If no image change occurs in the areas 601 established in the frames generated during the standby time (for example 10 seconds), then the control unit 39-3 signals the digital image processing device to enter the power save mode. In an embodiment, if no image change occurs in the areas 601 established in the frames generated during the standby time, then the control unit 39-3 controls the digital image processing device to enter a power saving mode.

In an embodiment, if an image change occurs between the areas 601 established in the frames generated before the counter counts the standby time (for example 10 seconds), the control unit 39-3 determines that the digital image processing device is held and resets the standby time. The procedure may repeat.

An embodiment of an apparatus for saving power of the digital image processing device shown in FIG. 1 according to another embodiment of the present invention will now be described with reference to FIG. 4.

The digital signal processing unit 39 compares between AF values of frames generated by the digital image processing device, and if no substantial change occurs in the AF values, the digital signal processing unit 39 determines that the digital image processing device is not held, and enters the digital image processing into a power save mode. In an embodiment, the digital signal processing unit 39 may signal that a power save mode may be entered, and then the digital image processing device may make a determination whether or not to enter a power save mode based on other factors.

In an embodiment, the digital signal processing unit 39 includes an AF value calculating unit 39-4, a second comparison unit 39-5, and the control unit 39-3. Although not shown, in an embodiment, the control unit 39-3 includes a counter for counting a standby time to enter the power save mode.

In an embodiment, the AF value calculating unit 39-4 calculates an integration value of a high frequency component of an image within an AF area of each frame every VD, so that the integration value becomes an AF value. FIG. 6A shows an example of the image photographed at a rate of 30 frames per second. FIG. 6B shows an example of the areas 601 established in the frames generated by the digital image processing device.

In an embodiment, the second comparison unit 39-5 compares the AF values of the frames.

In an embodiment, the control unit 39-3 controls the digital image processing device to enter the power save mode if no change occurs in the AF values. In an embodiment, the control unit 39-3 signals to the digital image processing device to enter the power save mode if no change occurs in the AF values. Since, in an embodiment, the AF values are changed every VD in real time while the digital image processing device moves, such information may be used to determine whether the digital image processing device is held.

Since a standby time (for example 10 seconds) for entering the power save mode is established in the control unit 39-3 including the counter, if no substantial change occurs in the AF values calculated from the frames generated by the digital image processing device during a standby period of time, (for example for 10 seconds), then in an embodiment the control unit 39-3 controls the digital image processing device to enter the power save mode. In an embodiment, the digital signal processing unit 39-3 may signal that a power save mode may be entered, and then the digital image processing device may make a determination whether or not to enter a power save mode based on other factors.

In an embodiment, if an image change occurs in the AF values calculated from the frames generated by the digital image processing device during the standby time (for example 10 seconds), then in an embodiment, the control unit 39-3 determines that the digital image processing device is held and resets the standby time. The procedure may repeat.

An apparatus for saving power of the digital image processing device shown in FIG. 1 according to an embodiment of the present invention will now be described with reference to FIG. 5.

In an embodiment, the digital signal processing unit 39 compares between AE values calculated from frames generated by the digital signal processing device, and if no substantial change occurs in the AE values, determines that the digital image processing device is not held, and enters the digital image processing device into a power save mode. In an embodiment, the digital signal processing unit 39 may signal that a power save mode may be entered, and then the digital image processing device may make a determination whether or not to enter a power save mode based on other factors.

In an embodiment, the digital signal processing unit 39 includes an AE value calculating unit 39-6, a third comparison unit 39-7, and the control unit 39-3. Although not shown, in an embodiment, the control unit 39-3 includes a counter for counting a standby time to enter the power save mode.

In an embodiment, the AE value calculating unit 39-6 calculates a brightness value of a high frequency component of an image within an AF area of each frame every VD, so that the brightness value becomes an AE value. FIG. 6A shows an example of the image photographed at a rate of 30 frames per second. FIG. 6B shows an example of the areas 601 established in the frames.

The third comparison unit 39-7 compares the AE values of the frames generated by the digital image processing device.

In an embodiment, the control unit 39-3 controls the digital image processing device to enter the power save mode if no substantial change occurs in the AE values calculated from frames generated by the device. Since, in an embodiment, the AE values are changed every VD in real time while the digital image processing device moves, such information may be used to determine whether the digital image processing device is held.

Since a standby time (for example 10 seconds) for entering the power save mode is established in the control unit 39-3 including the counter, if no substantial change occurs in the AE values calculated from the frames generated by the digital image processing device during the standby time of (for example 10 seconds), then, in an embodiment, the control unit 39-3 controls the digital image processing device to enter the power save mode. In an embodiment, the control unit 39-3 may signal that a power save mode may be entered, and then the digital image processing device may make a determination whether or not to enter a power save mode based on other factors.

In an embodiment, if a substantial image change occurs between the AE values of the frames generated by the digital image processing device before the counter counts to the standby time (for example 10 seconds), then the control unit 39-3 determines that the digital image processing device is being held and resets the standby time. The procedure may repeat.

In an embodiment, the digital image processing device may determine whether or not a change to an image is substantial based on values that indicate whether or not the device is being held. In an embodiment, the values may be predetermined, and may be shipped with the device. In an embodiment, the values may be determined by the digital image processing device based on values collected during use. In an embodiment, the user may calibrate the values.

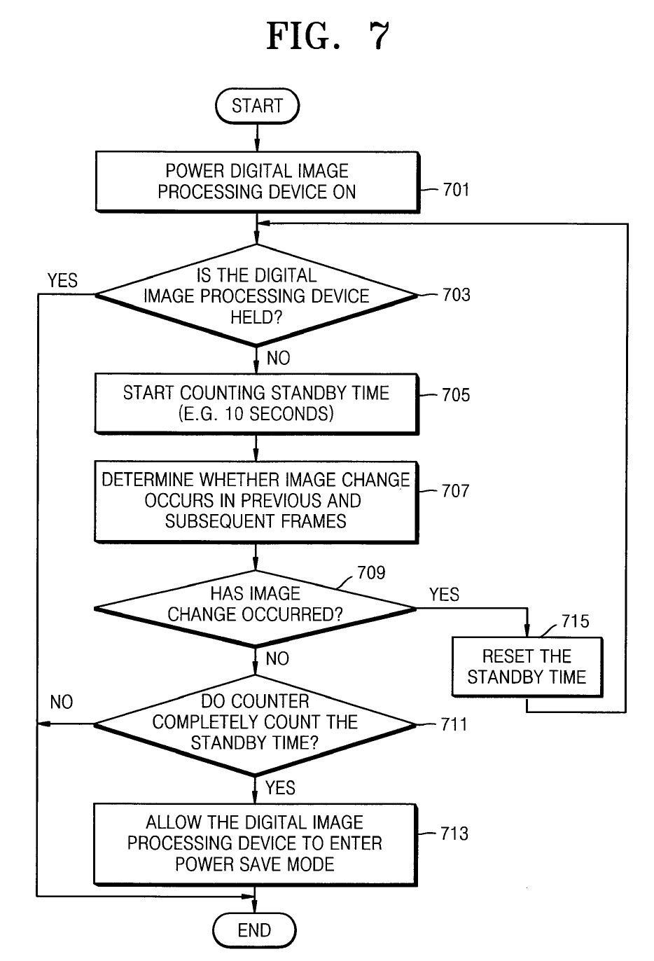

Methods of saving power used by a digital image processing device according to embodiments of the present invention will now be described in detail with reference to FIGS. 7 through 9. In embodiments, the methods may be performed by the digital image processing device shown in FIGS. 3 through 5. In an embodiment, the method may be performed by the digital signal processing unit 39 by using peripheral elements of the digital image processing device.

FIG. 7 is a flowchart illustrating an example of a method of saving power used by a digital image processing device according to an embodiment of the present invention. Referring to FIG. 7, if the digital image processing device is powered on (operation 701), the digital signal processing unit 39 determines whether the digital image processing device is held (operation 703).

If the digital signal processing unit 39 determines that the digital image processing device is not held, the digital signal processing unit 39 starts counting a standby time (for example 10 seconds) (operation 705). Although not shown, in an embodiment, the digital signal processing unit 39 includes a counter for counting the standby time to enter a power save mode.

While the counter counts the standby time, the digital signal processing unit 39 determines whether there are substantial changes between the images of the frames generated by the digital image processing device(operation 707). In an embodiment, the digital signal processing unit 39 establishes areas in each frame and compares the areas of the frames in order to determine whether there are substantial changes between the images of the frames generated by the digital image processing device. FIG. 6A shows an example of the image photographed at a rate of 30 frames per second. FIG. 6B shows an example of the areas 601 established in the frames generated by the digital image processing device. In an embodiment, the areas 601 may be AF areas.

The digital signal processing unit 39 determines if the images of the frames have substantially changed (operation 709). If substantially no change occurs in the areas 601 established in the frames, the digital signal processing unit 39 determines whether the counter has reached the standby time (operation 711).

If substantially no change occurs in the areas 601 established in the frames, and the digital signal processing unit 39 determines that the counter has reached the standby time, then in an embodiment, the digital signal processing unit 39 signals to the digital image processing device to enter the power save mode (operation 713).

Meanwhile, if the areas 601 established in the frames have substantially changed, then, in an embodiment, the digital signal processing unit 39 determines that the digital image processing device is held and resets the standby time (operation 715).

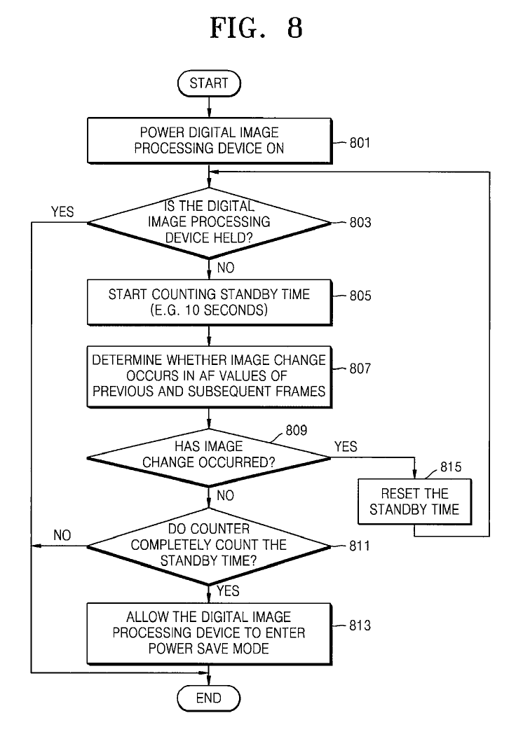

An embodiment of a method of saving power of the digital image processing device will now be described with reference to FIG. 8. Referring to FIG. 8, if the digital image processing device is powered on (operation 801), the digital signal processing unit 39 determines whether the digital image processing device is held (operation 803).

If the digital signal processing unit 39 determines that the digital image processing device is not held, the digital signal processing unit 39 starts counting a standby time, e.g. 10 seconds (operation 805). Although not shown, in an embodiment, the digital signal processing unit 39 includes a counter for counting the standby time to enter a power save mode.

While the counter counts the standby time, the digital signal processing unit 39 determines whether there is a change in AF values calculated from frames generated by the digital image processing device (operation 807). In an embodiment, the digital signal processing unit 39 calculates an integration value of a high frequency component of an image within an AF area of each frame every VD, uses the integration values as the AF values, and compares the AF values in order to determine whether there is the change in the AF values of frames. FIG. 6A shows an example of the image photographed at a rate of 30 frames per second. FIG. 6B shows an example of the areas 601 established in the frames.

The digital signal processing unit 39 determines if the AF values of frames have substantially changed (operation 809). In an embodiment, the AF values substantially change every VD in real time while the digital image processing device moves, such information may be used to determine whether the digital image processing device is held.

If no change occurs in the AF values of the previous and subsequent frames, the digital signal processing unit 39 determines whether the counter completely counts the standby time (operation 811).

If no substantial change occurs in the AF values calculated from the frames, and the digital signal processing unit 39 determines that the counter reached the standby time, then, in an embodiment, the digital signal processing unit 39 allows the digital image processing device to enter the power save mode (operation 813).

In an embodiment, if the AF values calculated from the frames have substantially changed, then, in an embodiment, the digital signal processing unit 39 determines that the digital image processing device is held and resets the standby time (operation 815).

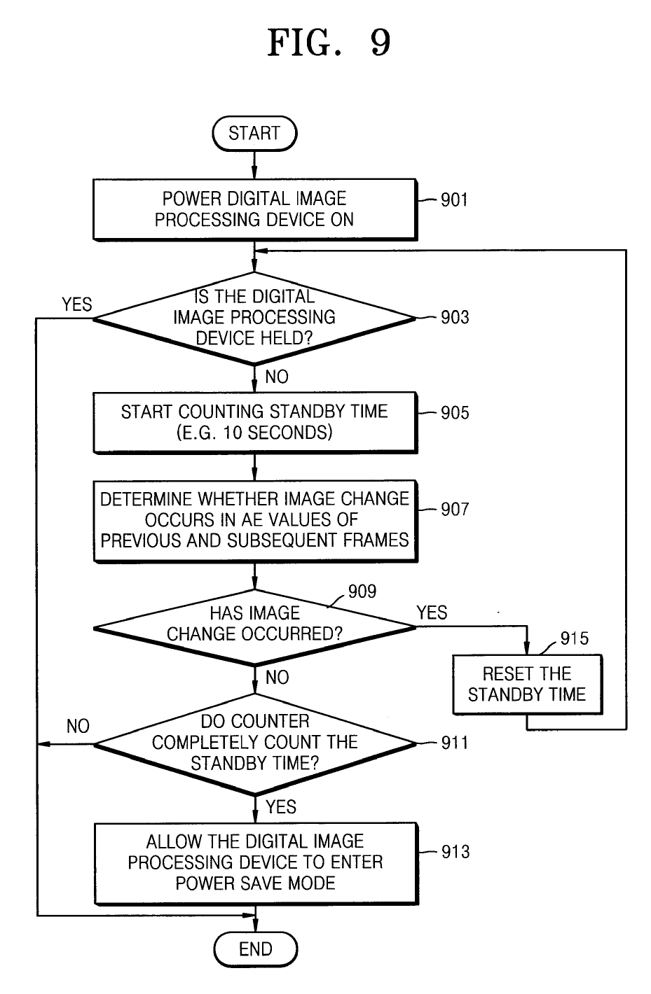

An embodiment of a method of saving power used by a digital image processing device will now be described with reference to FIG. 9. In an embodiment, referring to FIG. 9, if the digital image processing device is powered on (operation 901), the digital signal processing unit 39 determines whether the digital image processing device is held (operation 903).

In an embodiment, if the digital signal processing unit 39 determines that the digital image processing device is not held, then the digital signal processing unit 39 starts counting a standby time (for example 10 seconds) (operation 905). Although not shown, in an embodiment, the digital signal processing unit 39 includes a counter for counting the standby time to enter a power save mode.

In an embodiment, while the counter counts the standby time, the digital signal processing unit 39 determines whether there is a substantial change in AE values calculated from frames (operation 907). The digital signal processing unit 39 calculates a brightness value of a high frequency component of an image within an AF area of each frame every VD, and may use the integration values as the AE values, and may compare the AE values in order to determine whether there is the change in the AE values of calculated from the frames. FIG. 6A shows an example of the image photographed at a rate of 30 frames per second. FIG. 6B shows an example of the areas 601 established in the frames.

The digital signal processing unit 39 determines if the AE values calculated from the frames have substantially changed (operation 909). In an embodiment, since the AF values will substantially change every VD in real time while the digital image processing device moves, such information may be used to determine whether the digital image processing device is held.

In an embodiment, if no change occurs in the AE values calculated from the frames, the digital signal processing unit 39 determines whether the counter reached the standby time (operation 911).

In an embodiment, if no change occurs in the AE values calculated from the frames, and the digital signal processing unit 39 determines that the counter reached the standby time, then, in an embodiment, the digital signal processing unit 39 signals the digital image processing device to enter the power save mode (operation 913). In an embodiment, the digital signal processing unit 39 enters the digital image processing device into a power save mode.

Meanwhile, if the AE values calculated from the frames have substantially changed, then, in an embodiment, the digital signal processing unit 39 determines that the digital image processing device is held and resets the standby time (operation 915).

As described above, in embodiments, if a digital image processing device is not held and the image of the frames generated remain substantially unchanged, then the digital image processing device enters a power save mode, thereby reducing the power consumed by the device.

While the present invention has been particularly shown and described with reference to an embodiment thereof, it will be understood by those of ordinary skill in the art that various changes in form and detail may be made therein without departing from the spirit and scope of the present invention as defined by the following claims.

What is claimed is:

1. A power saving digital image processing device comprising:
a digital image processing unit arranged to determine that the device is not being held and to signal to the device to enter a power save mode if substantially no image change occurs between frames generated by the digital image processing device.

2. The device of claim 1, wherein the digital image processing unit comprises:
an area establishing unit arranged to establish areas in the generated frames;
a comparison unit arranged to compare between the established areas of the generated frames; and
a control unit arranged to determine that the device is not being held and to signal to the device to enter a power save mode if substantially no image change occurs between the established areas of the generated frames.

3. The device of claim 2, wherein the control unit is arranged to determine that the device is not being held and to signal to the device to enter the power save mode if substantially no image change occurs between the established areas of frames generated for a predetermined period of time by the digital image processing device.

4. The device of claim 3, wherein the control unit is arranged to determine if a substantial image change occurs between the established areas of frames generated by the digital image processing device during the predetermined period of time, and if a substantial image change occurs, then determine that the digital image processing device is being held and reset the predetermined period of time.

5. A power saving digital image processing device comprising:
a digital image processing unit arranged to determine that the device is not being held and arranged to signal to the device to enter a power save mode if substantially no change occurs between auto-focus (AF) values calculated from frames generated by the digital image processing device

6. The device of claim 5, wherein the digital image processing unit comprises:
an AF value calculating unit arranged to calculate an integration value of a high frequency component from a predetermined area of the frames;
a comparison unit arranged to compare between the AF values calculated from the predetermined area of the frames; and
a control unit arranged to signal to the device to enter a power save mode if substantially no change occurs between the AF values calculated from the frames.

7. The device of claim 6, wherein the control unit is arranged to signal to the device to enter the power save mode if substantially no change occurs between the calculated AF values calculated from the frames generated within the predetermined period of time.

8. The device of claim 7, wherein the control unit is arranged to reset the predetermined period of time, if a substantial change occurs between the AF values calculated from the frames generated within the predetermined period of time.

9. A power saving digital image processing device comprising:
a digital image processing unit arranged to determine that the device is not being held and to signal to the device to enter a power save mode if substantially no change occurs between AE values calculated from frames.

10. The device of claim 9, wherein the digital image processing unit comprises:
an AE value calculating unit arranged to calculate a brightness value of an image from a predetermined area of the frame;
a comparison unit arranged to compare between AE values calculated from the predetermined area of the frames; and
a control unit arranged to signal to the device to enter a power save mode if substantially no change occurs between the AE values calculated from the frames.

11. The device of claim 10, wherein the control unit is arranged to signal to the device to enter the power save mode if substantially no change occurs between the AE values of the frames generated within the predetermined period of time.

12. The device of claim 11, wherein the control unit is arranged to reset the predetermined period of time if a substantial change occurs between the AE values calculated from the frames generated within the predetermined period of time.

13. A method of operating a digital image processing device, the method comprising:
determining whether a substantial change occurs between frames of images generated by the device; and
if no substantial change occurs, then determining that the digital image processing device is not held, and signaling to the device to enter a power save mode.

14. The method of claim 13, wherein determining whether a substantial change occurs further comprises:
determining whether a substantial change occurs between frames of images generated by the device for a predetermined period of time, and if a substantial change occurs within the predetermined time, then resetting the predetermined period of time, otherwise determining that no substantial change occurred.

15. A method of operating a digital image processing device, the method comprises:
determining whether a substantial change occurs between AF values calculated from frames generated by the device; and
if no substantial change occurs, then determining that the digital image processing device is not held, and signaling to the device to enter a power save mode.

16. The method of claim 15, wherein determining whether a substantial change occurs further comprises:
determining whether a substantial change occurs between calculated AF values of frames generated by the device for a predetermined period of time, and if a substantial change occurs within the predetermined time, then resetting the predetermined period of time, otherwise determining that no substantial change occurred.

17. A method of operating a digital image processing device, the method comprises:
determining whether a substantial change occurs between AE values calculated from frames generated by the device; and
if no substantial change occurs, then determining that the digital image processing device is not held, and signaling to the device to enter a power save mode.

18. The method of claim 17, wherein the determining whether a substantial change occurs further comprises:
determining whether a substantial change occurs between AE values calculated from frames generated by the device for a predetermined period of time, and if a substantial change occurs within the predetermined time, then resetting the predetermined period of time, otherwise determining that no substantial change occurred.
